(19) United States
(12) Patent Application Publication
(10) Pub. No.: US 2014/0019603 A1
(43) Pub. Date: Jan. 16, 2014

(54) SYSTEMS AND METHODS INVOLVING INTERACTIVE QUEUING

(71) Applicant: Gregory A. Dunko, Cary, NC (US)

(72) Inventor: Gregory A. Dunko, Cary, NC (US)

(73) Assignee: HTC CORPORATION, Taoyuan City (TW)

(21) Appl. No.: 13/548,642

(22) Filed: Jul. 13, 2012

(51) Int. Cl. G06F 15/173

(52) U.S. Cl. 709/223

(57) ABSTRACT

Systems and methods for providing interactive queuing are provided. In this regard, a representative method includes: assigning users of electronic devices to corresponding positions of a queue, each of the users being associated with a corresponding one of the electronic devices; and providing queue information to the users via the electronic devices.

### TECHNICAL FIELD

The present disclosure generally relates to queuing.

### BACKGROUND

Queuing at a venue such as a restaurant may be an unpleasant experience that provides limited flexibility to those participating in the queue. One commonplace method for establishing a queue involves the use of dedicated devices that communicate with a central workstation, which is managed at a reception area. In using this method, a customer checks in at the reception area and is provided with one of the dedicated devices. When a table becomes available, an alert provided from the central workstation is communicated to the dedicated device thereby informing the customer of the table availability. Notably, this method tends to lack flexibility in that the customers have limited ability to alter positions in the queue among themselves.

### SUMMARY

Systems and methods involving interactive queuing are provided. Briefly described, one embodiment, among others, is a method comprising: assigning users of electronic devices to corresponding positions of a queue, each of the users being associated with a corresponding one of the electronic devices; and providing queue information to the users via the electronic devices.

Another embodiment is a system for providing interactive queuing for users of electronic devices, the system comprising: a queuing system comprising computer-executable instructions operative to: assign a position in a queue for each of the electronic devices associated with each of the users; and communicate position information corresponding to assigned positions in the queue to the respective electronic devices such that a first of the electronic devices includes first position information indicative of a first position in the queue and a second of the electronic devices includes second position information indicative of a second position in the queue.

Another embodiment is an electronic device for use with a queuing system, the electronic device comprising: a communications interface operative to communicate with the queuing system; memory operative to store position information corresponding to a position in a queue assigned by the queuing system; a processor; and computer-executable instructions operative to receive queue information corresponding to positions in the queue.

Other systems, methods, features, and advantages of the present disclosure will be or may become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram of an example embodiment of a system involving interactive queuing.

FIG. 2 is a flowchart depicting an example embodiment of a method that may be performed by the embodiment of FIG. 1.

FIG. 3 is a schematic diagram of another example embodiment of a system.

FIG. 4 is a schematic diagram showing detail of a possible implementation of the electronic device of FIG. 3.

FIG. 5 is a schematic diagram depicting signal flows of another example embodiment of a system involving interactive queuing.

FIG. 6 is a flowchart depicting functionality that may be performed by an example embodiment of a system.

FIG. 7 is a schematic diagram depicting signal flows of another example embodiment of a system involving interactive queuing.

### DETAILED DESCRIPTION

Having summarized various aspects of the present disclosure, reference will now be made in detail to that which is illustrated in the drawings. While the disclosure will be described in connection with these drawings, there is no intent to limit the scope of legal protection to the embodiment or embodiments disclosed herein. Rather, the intent is to cover all alternatives, modifications and equivalents included within the spirit and scope of the disclosure as defined by the appended claims.

In this regard, systems and methods involving interactive queuing are provided. In some embodiments, users of electronic devices are assigned positions in a queue while being able to use the electronic devices to receive queue information associated with the queue in order to enhance the experience of the user. In some embodiments, the queue information provided by an electronic device may be an approximate wait time based on the current queue position. Additionally, or alternatively, the queue information may be associated with the queue destination.

In some embodiments, users of the electronic devices may be enabled to modify their assigned positions in a queue. As described in detail below, this may involve users of the devices interacting directly with each other and/or indirectly via a queuing system. Regardless of the particular manner used, positions of users may be swapped at the discretion of the users. In some embodiments, this may involve the operator of the queuing system offering an incentive for swapping, whereas in other embodiments, an incentive may be offered by a user desiring a better position in the queue. Notably, an electronic device for facilitating the functionality of the system may be a user's smartphone.

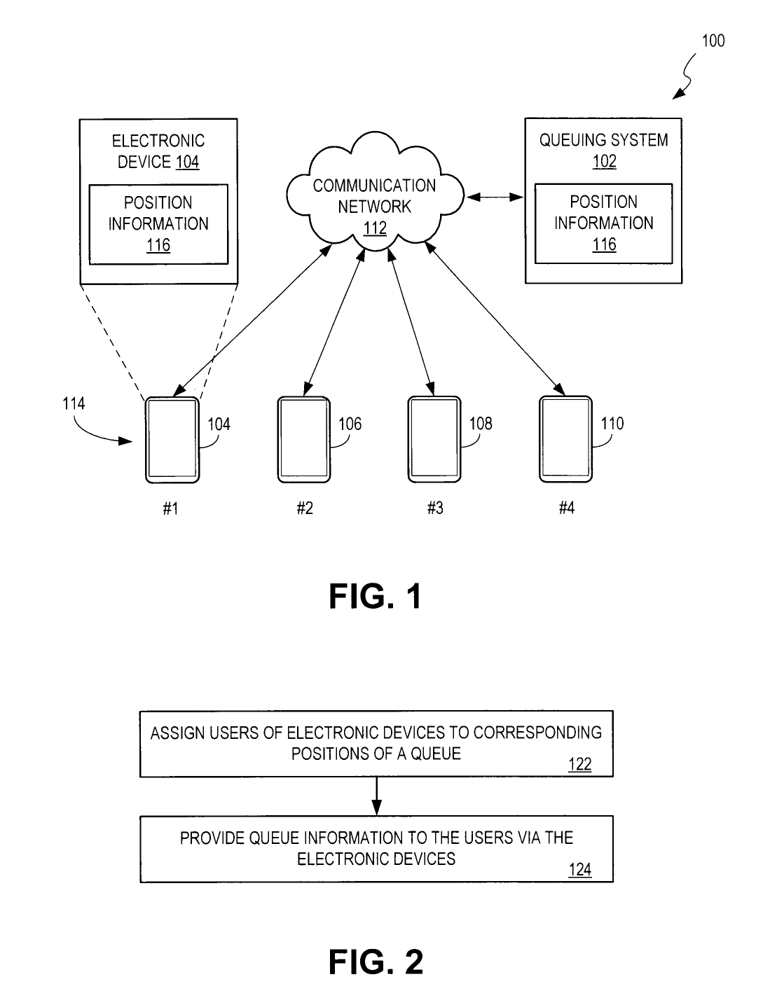

FIG. 1 is a schematic diagram of an example embodiment of a system involving interactive queuing. As shown in FIG. 1, system 100 includes queuing system 102 and multiple electronic devices (104, 106, 108 and 110) that communicate via communications network 112. Notably, network 112 may comprise one or more wired and/or wireless networks that may use one or more communication protocols.

In operation, the queuing system assigns a position in queue 114 for each of the electronic devices. Since each of the electronic devices is associated with a user, the assigning of the positions provides a queue position to each of the users. As shown in FIG. 1, electronic devices 104, 106, 108 and 110 are assigned queue positions 1-4, respectively.

In the depicted embodiment, positions in the queue are assigned by the queuing system, which communicates position information (e.g., position information 116) corresponding to the appropriate queue position to each of the electronic devices. Thus, position information 116 corresponds to the first position in the queue.

FIG. 2 is a flowchart depicting an example embodiment of a method that may be performed by the embodiment of FIG. 1. As shown in FIG. 1, the method may be construed as beginning at block 122, in which users of electronic devices are assigned to corresponding positions of a queue. Notably, each of the users is associated with a corresponding one of the electronic devices. In block 124, queue information is provided to the users via the electronic devices. By way of example, queue information may include information associated with the queue destination (such as a menu for a restaurant queue) or of the queue itself (such as approximate wait time and/or position information).

In some embodiments, the users also are enabled to modify positions in the queue. For example, a first user of a first of the electronic devices and a second user of a second of the electronic devices may be enabled to modify the positions via the first and second electronic devices, respectively, so that their assigned positions in the queue are swapped. In some embodiments, the swapping of positions may be facilitated by the position information associated with the respective electronic devices being swapped. Thus, in the previous example, after such a swap, the second electronic device stores position information indicative of the first position in the queue (which was previously stored by the first device) and the first electronic device stores position information indicative of the second position in the queue (which was previously stored by the second device).

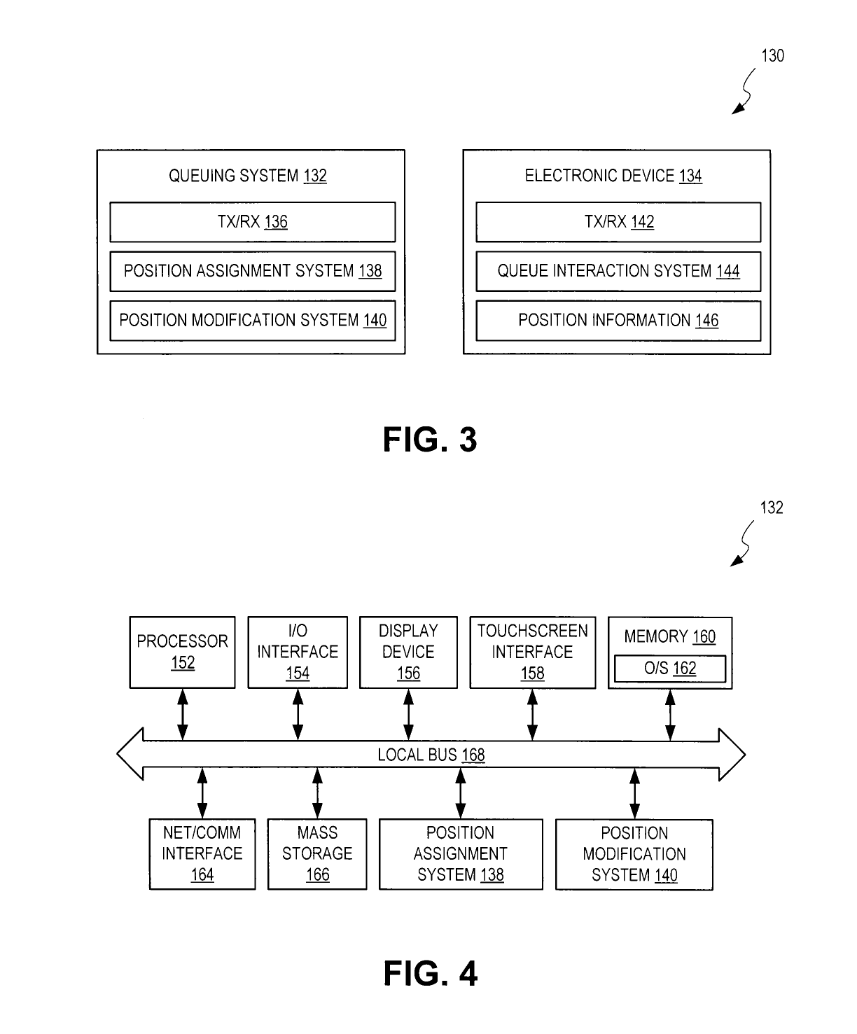

FIG. 3 is a schematic diagram of another example embodiment of a system involving interactive queuing. As shown in FIG. 3, system 130 includes a queuing system 132 and an electronic device 134. Notably, the electronic device (which is one of multiple electronic devices usable with the system and which may be configured as a smartphone in some embodiments) communicates with the queuing system via a communications network (not shown).

The queuing system incorporates transmitter/receiver components 136, a position assignment system 138 and a position modification system 140. The electronic device incorporates transmitter/receiver components 142, a queue interaction system 144 and position information 146. In some embodiments, the position assignment system 138 and the position modification system 140 may use a position\identity lookup database to determine various users' position in the queue.

In operation, the queuing system assigns a position in a queue (not shown) to the electronic device. This is accomplished by the position assignment system associating position information with an electronic device and then providing the position information to the transmitter/receiver components 136 for transmission to the corresponding electronic device. In this example, the position assignment system associates position information 146 with electronic device 134. Electronic device 134 stores the position information.

In the event that the user of electronic device 134 desires to modify the corresponding queue position, the queue interaction system 144 enables the user of the electronic device to transmit information associated with such a desire. By way of example, the information may be provided as an offer to swap positions with other users in the queue. In some embodiments, communicating the offer is performed by direct communication between electronic device 134 and other devices (not shown) that are associated with the queue. For such direct communications, the queuing system may facilitate this contact by providing contact information for use by the electronic devices.

In this embodiment, the queue interaction system of the electronic device is configured to receive information corresponding to a desire to swap positions. For instance, the information may correspond to one or more of a desired queue position, a range of desired queue positions, an improved queue position, and an offer or amount of credit the user is willing to provide for swapping positions, among possible others. This information is input to the electronic device by the user, with the queue interaction system facilitating transmission of the information. Note that a “request” may include an identification photo, an excuse or explanation (e.g., “it's my birthday”) and/or other information. Additionally, the “offer” may include restaurant credit, content exchange and/or any other item of value that might be exchanged.

Position modification system 140 receives the information from the queue interaction system 144 and may forward the information to electronic devices associated with appropriate positions in the queue. By way of example, if a user desires to swap positions with a user in either the current first or second positions of the queue, the position modification system may only transmit the information to those users.

Similarly, if one of the users associated with a desirable queue position would like to accept the offer to swap positions, the information may be provided to the position modification system by the queue interaction system of the corresponding electronic device. Thus, the position modification system facilitates communication between those in the queue positions. Responsive to such an acceptance, position information originally associated with the user offering to swap may be exchanged with position information associated with the user accepting the swap.

In some embodiments, a position modification system may facilitate bidding for a swap position. By way of example, a position modification system may track and communicate a current highest bid among the users in the queue. Notably, various manners of bidding may be used. For instance, some may be user-driven (as described above), while others may be driven by the establishment responsible for the queue.

Establishment-driven embodiments may involve various aspects of queue management. By way of example, an establishment may use a system to offer a form of credit for a user willing to swap queue positions with another. In such an embodiment, the credit may be provided to the first qualified user that responds to an offer to swap queue positions. In some embodiments, the credit may be provided by the establishment as a cash credit or discount toward purchases, for example. In other embodiments, the credit may be provided by the user that desired swapping for the better queue position such that the user pays for the credit, which is then provided to the user accepting the offer.

FIG. 4 is a schematic diagram of queuing system 134 of FIG. 3. As shown in FIG. 4, queuing system 134 includes a processing device (processor) 152, input/output interfaces 154, a display device 156, a touchscreen interface 158, a memory 160, operating system 162, a network/communication interface 164, and a mass storage 166, with each communicating across a local data bus 168. Additionally, the system incorporates position assignment system 138 and position modification system 140.

The processing device 152 may include a custom made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 160 may include any one of a combination of volatile memory elements (e.g., random-access memory (RAM, such as DRAM, and SRAM, etc.)) and nonvolatile memory elements. The memory typically comprises native operating system 162, one or more native applications, emulation systems, or emulated applications for any of a variety of operating systems and/or emulated hardware platforms, emulated operating systems, etc. For example, the applications may include application specific software which may comprise some or all the components of the system. In accordance with such embodiments, the components are stored in memory and executed by the processing device. Note that although depicted as not being resident in memory 160, position assignment system 138 and position modification system 140 may be stored in memory 160.

Touchscreen interface 158 is configured to detect contact within the display area of the display 156 and provides such functionality as on-screen buttons, menus, keyboards, soft-keys, etc., that allows users to navigate user interfaces by touch. In this embodiment, the touchscreen interface and display device constitute a queue management interface for enabling a user of the queuing system to assign queue positions to corresponding electronic devices.

One of ordinary skill in the art will appreciate that the memory may, and typically will, comprise other components which have been omitted for purposes of brevity. Note that in the context of this disclosure, a non-transitory computer-readable medium stores one or more programs for use by or in connection with an instruction execution system, apparatus, or device.

With further reference to FIG. 4, network/communication interface 164 comprises various components used to transmit and/or receive data over a networked environment, such as receiver 142 of FIG. 3. By way of example, such components may include a wireless communications interface. When such components are embodied as an application, the one or more components may be stored on a non-transitory computer-readable medium and executed by the processing device.

In operation, position assignment system 138 assigns queue positions to electronic devices so that users of the devices are aware of their current positions in a queue. In some embodiments, this is accomplished by communicating position information form the queuing system to the electronic devices. Position modification system 140 interacts with the electronic devices in a manner that facilitates swapping of queue positions among the various users of the electronic devices. In some embodiments, this may involve receiving information corresponding to a desire to swap queue locations and various other functions associated with brokering a swap.

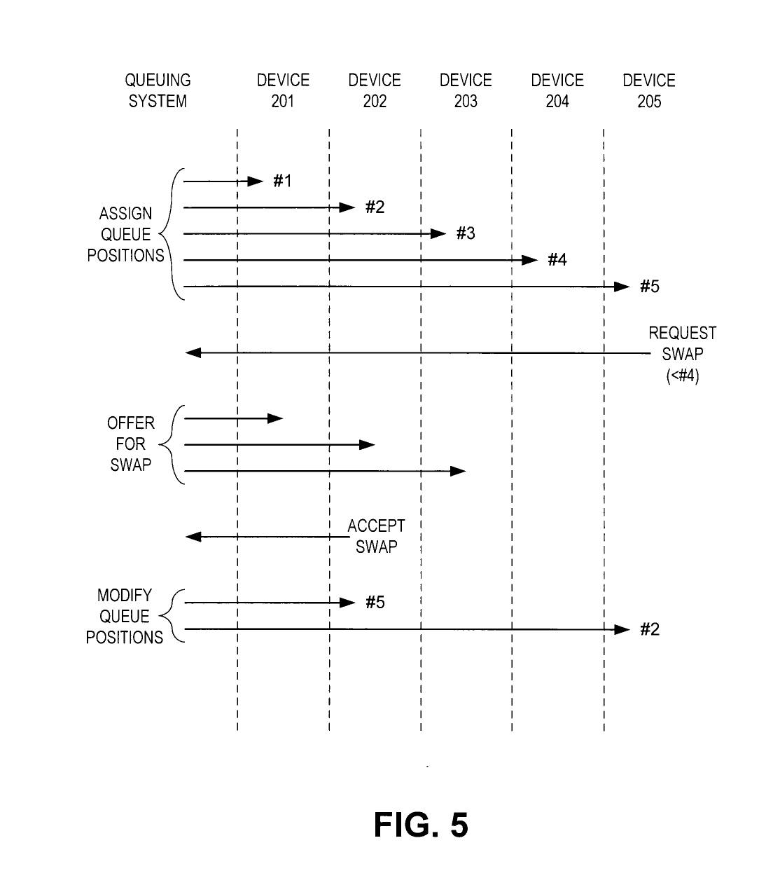

FIG. 5 is a schematic diagram showing representative signal flows that may be performed in effecting a swap of queue positions such as via a position assignment system and/or a position modification system. As shown in FIG. 5, various system components are represented, such as a queuing system (denoted along the leftmost column), and electronic devices 201-205, with each of the component functions being separated by a vertical dashed line. Assume in this scenario that the users of devices 201-205 desire to be positioned within a queue managed by the queuing system.

As shown within the upper portion of FIG. 5, the queuing system assigns queue positions to the devices 201-205. In this embodiment, this is accomplished by an associated position assignment system (not shown) facilitating communication of position information to each of the devices. In this case, position information representative of each of the queue positions #1-#5 is assigned to devices 201-205, respectively.

In the next lower portion of FIG. 5, it is shown that the user of device 205 desires a swap of queue position in order to obtain a new queue position that is better than position #4 (i.e., a queue position less than or equal to #3). The left facing arrow indicates that the desire for swap is communicated from device 205 to the queue system.

The queue system responds to the request for swap by informing relevant users in the queue of the request. In this case, the users in queue positions #1-#3 are informed via devices 201-203, respectively. Note that the user in queue position #4 is not notified of the request because that user does not hold a queue position desired by the request.

Responsive to receiving information corresponding to the request for swap, the user of device 202 accepts the request for swap by communicating acceptance to the queuing system via device 202. Thereafter, the queuing system modifies the queue positions associated with devices 202 and 205. This is accomplished by providing updated position information such that the position information carried by device 202 corresponds to position #5, and that carried by device 205 corresponds to position #2. Note that the queuing system may facilitate “direct” contact between users (e.g., possibly by providing anonymous contact information that enables devices to communicate directly for the duration of this negotiation and transaction).

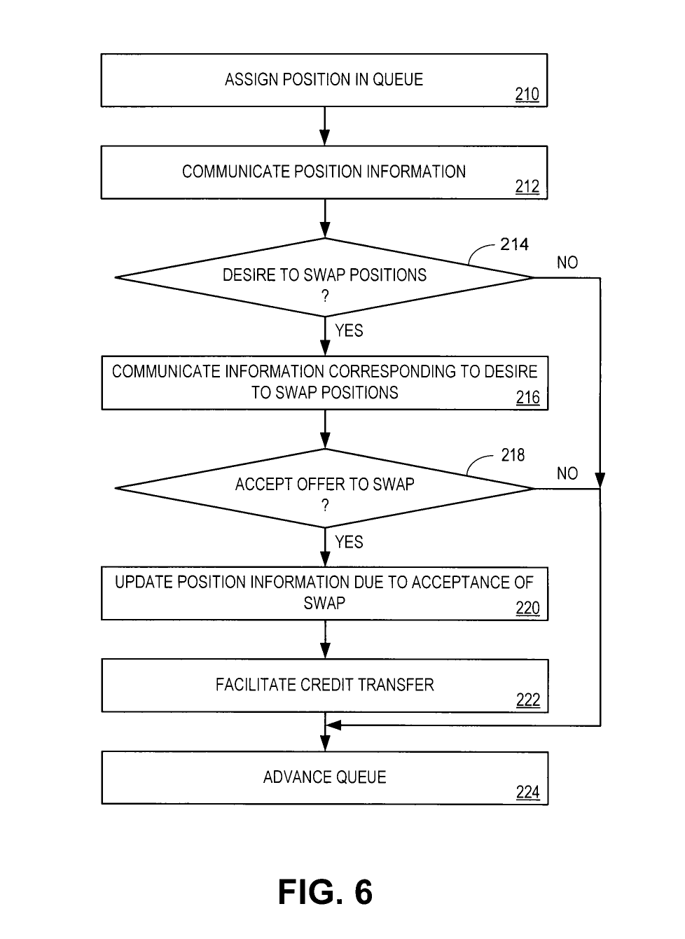

FIG. 6 is a flowchart depicting functionality that may be performed by another example embodiment of a system. As shown in FIG. 6, the functionality (or method) may be construed as beginning at block 210, in which queue positions are assigned to users. In block 212, position information corresponding to an assigned queue position is communicated to the user. In some embodiments, this may involve a queuing system communicating the position information to an electronic device of the user, such as a user's smartphone.

In block 214, a determination is made as to whether a user desires to swap positions in the queue. If it is determined that a user does desire a swap (which may be indicated by the user informing a manager of the queue via the electronic device or otherwise), the process may proceed to block 216, in which information corresponding to the desire to swap is communicated to the users in the queue. Notably, communicating of the desire to swap may be made only to users occupying desired queue positions in some embodiments.

In block 218, a subsequent determination is made as to whether an offer to swap is accepted by an appropriate user of the queue (i.e., a user occupying a desired queue position). If the offer to swap is accepted, the process may proceed to block 220, in which position information is updated due to acceptance of the swap. By way of example, position information associated with the user desiring the swap and the user accepting the swap may be exchanged. Thereafter, the process may proceed to block 222, in which a credit transfer may be facilitated. Notably, in order to entice a user to accept an offer to swap queue positions, an incentive for swapping may be provided. Forms of incentive may vary and may include monetary credit or a discount that may be applied at the establishment associated with the queue. It should also be noted that the incentive may be provided by the user desiring the swap and/or the management of the queue.

After block 222 (or after negative determinations are made with respect to blocks 214 and 218), the process may proceed to block 224, in which users in the queue are advanced to the next positions.

If embodied in software, it should be noted that each block depicted in the flowchart of FIG. 6 (or any of the other flowcharts) represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

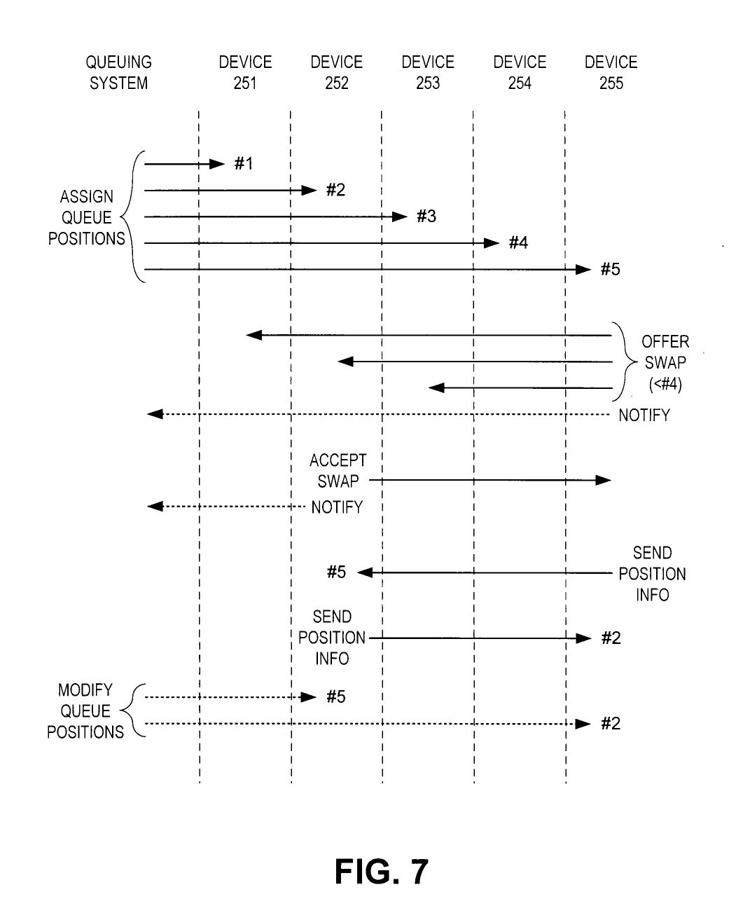

FIG. 7 is a schematic diagram showing representative signal flows that may be performed by another embodiment of a queuing system in effecting a swap of queue positions. As shown in FIG. 7, various system components are represented, such as a queuing system (denoted along the leftmost column), and electronic devices 251-255.

As shown, the queuing system assigns queue positions to the devices 251-255. In this embodiment, this is accomplished by an associated position assignment system (not shown) facilitating communication of position information to each of the devices. In this case, position information representative of each of the queue positions #1-#5 is assigned to devices 251-255, respectively.

In the next lower portion of FIG. 7, it is shown that the user of device 205 desires a swap of queue position in order to obtain a new queue position that is better than position #4 (i.e., a queue position less than or equal to #3). In this embodiment, the desire for swap is communicated from device 255 to each of the devices currently associated with a potentially desirable queue position. Specifically, the users in queue positions #1-#3 are informed via devices 251-253, respectively. In some embodiments, the queue system also receives a notification of the desire to swap (indicated by the dashed, arrowed line).

Responsive to receiving information corresponding to the request for swap, the user of device 252 accepts the request for swap by communicating acceptance to device 255. In some embodiments, the queue system also receives a notification of the acceptance. Thereafter, devices 252 and 255 exchange position information such that the position information carried by device 202 corresponds to position #5, and that carried by device 205 corresponds to position #2. In an alternative embodiment, the queue system may provide the position information corresponding tot he agreed upon swap to the appropriate devices as indicated by the dashed, arrowed lines at the bottom of FIG. 7.

It should be emphasized that the above-described embodiments are merely examples of possible implementations. Many variations and modifications may be made to the above-described embodiments without departing from the principles of the present disclosure. By way of example, the systems described may be implemented in hardware, software or combinations thereof. All such modifications and variations are intended to be included herein within the scope of this disclosure and protected by the following claims.

At least the following is claimed:

1. A system for providing interactive queuing for users of electronic devices, the system comprising:
a queuing system comprising computer-executable instructions operative to:
assign a position in a queue for each of the electronic devices associated with each of the users; and
communicate position information corresponding to assigned positions in the queue to the respective electronic devices such that a first of the electronic devices includes first position information indicative of a first position in the queue and a second of the electronic devices includes second position information indicative of a second position in the queue.

2. The system of claim 1, wherein the queuing system is further operative to facilitate swapping of the assigned positions responsive to first and second ones of the users providing swap information corresponding to a desire to swap positions in the queue such that the second of the electronic devices includes the first position information indicative of the first position in the queue and the first of the electronic devices includes the second position information indicative of the second position in the queue.

3. The system of claim 2, wherein the queuing system is further operative to provide a credit as incentive for a second user to swap positions with the first user.

4. The system of claim 1, wherein the queuing system further comprises a queue management interface operative to receive inputs corresponding to users to be placed in the queue.

5. The system of claim 1, wherein the queuing system further comprises a processor operative to execute the computer-executable instructions.

6. The system of claim 1, wherein:
the queuing system further comprises a network server; and
the computer-executable instructions are stored on the network server.

7. An electronic device for use with a queuing system, the electronic device comprising:
a communications interface operative to communicate with the queuing system;
memory operative to store position information corresponding to a position in a queue assigned by the queuing system;
a processor; and
computer-executable instructions operative to receive queue information corresponding to positions in the queue.

8. The system of claim 7, wherein the electronic device further comprises computer-executable instructions operative to produce swap information corresponding to a desire of a user of the electronic device to swap positions in the queue.

9. The system of claim 7, wherein the electronic device is a smartphone.

10. A method for providing interactive queuing comprising:
assigning users of electronic devices to corresponding positions of a queue, each of the users being associated with a corresponding one of the electronic devices; and
providing queue information to the users via the electronic devices.

11. The method of claim 10, wherein providing queue information comprises:
communicating first position information corresponding to a first of the assigned positions to the first of the electronic devices; and
communicating second position information corresponding to a second of the assigned positions to the second of the electronic devices.

12. The method of claim 10, wherein providing queue information comprises informing the users of respective current positions within the queue via the electronic devices.

13. The method of claim 10, further comprising enabling a first user of a first of the electronic devices and a second user of a second of the electronic devices to modify the positions via the first and second electronic devices, respectively, such that the assigned positions of the first user and the second user in the queue are swapped.

14. The method of claim 13, wherein enabling further comprises communicating an offer of the first user to swap positions to others of the users in the queue.

15. The method of claim 14, wherein communicating the offer is performed by direct communication between the electronic devices.

16. The method of claim 15, wherein enabling further comprises communicating acceptance of the offer by the second user.

17. The method of claim 16, wherein enabling further comprises, responsive to the acceptance:
communicating the first position information to the second of the electronic devices; and
communicating the second position information to the first of the electronic devices.

18. The method of claim 13, wherein enabling further comprises:
facilitating bidding among the users for the current position of the first user; and
associating a credit with the first user responsive to the first user swapping positions in the queue with a winning user as a result of the bidding.

19. The method of claim 18, wherein associating a credit further comprises the winning user paying for the credit.

20. The method of claim 18, wherein:
the queue is associated with a business; and
associating a credit further comprises the business providing a discount to the first user.

21. The method of claim 18, wherein:
the queue is associated with a business; and
associating a credit further comprises the business providing the credit to the first user.
